(19) United States
(12) Patent Application Publication
(10) Pub. No.: US 2024/0087417 A1
(43) Pub. Date: Mar. 14, 2024

(54) ELECTRONIC GAMING SYSTEMS AND METHODS WITH IMPROVED FEATURE GAME HAVING A USER PICK SELECTION

(71) Applicant: Aristocrat Technologies, Inc., Las Vegas, NV (US)

(72) Inventors: John Ludwick, Reno, NV (US); Christmas Uberuaga, Reno, NV (US)

(21) Appl. No.: 18/189,917

(22) Filed: Mar. 24, 2023

Related U.S. Application Data
(60) Provisional application No. 63/375,512, filed on Sep. 13, 2022.

(51) Int. Cl. G07F 17/32

(52) U.S. Cl. CPC G07F 17/3262; G07F 17/3213; G07F 17/3258; G07F 17/3267; G07F 17/34

(57) ABSTRACT

An electronic gaming device that includes a display device, an input device, a memory device, and a processor is described. The processor is programmed to cause: display of a base game outcome, determine a trigger symbol is displayed in the base game outcome, display of a feature game including a plurality of user selectable pick icons and a plurality of collection areas, display of a plurality of award icons each of which includes an award value wherein each of the plurality of award icons is assigned to one of the plurality of collection areas, receive a selection of a pick icon, based on the received selection transform one of the plurality of collection areas into an activated collection area, and award each award value included on the plurality of award icons assigned to the activated collection area.

### CROSS REFERENCE TO RELATED APPLICATIONS

This application claims the benefit of priority to U.S. Provisional Patent Application No. 63/375,512, filed Sep. 13, 2022, the contents and disclosure of which are incorporated herein by reference in their entirety.

### TECHNICAL FIELD

The field of disclosure relates generally to electronic gaming, and more specifically, to electronic gaming systems and methods that include a feature game that enables user-initiated pick selections that provide improved variability in game play and game outcomes while conserving computational resources.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

### BRIEF DESCRIPTION

In one aspect, an electronic gaming device is described. The gaming device includes a display device, an input device operable to receive a player input, a memory device for storing instructions, and a processor in communication with the display device, the input device, and the memory device. The instructions, when executed by the processor, cause the processor to: display a base game outcome of a base game on the display device wherein the base game outcome includes a plurality of displayed symbols included on a plurality of reels, determine that the plurality of displayed symbols includes a trigger symbol, in response to the display of the trigger symbol, display a feature game comprising a plurality of user selectable pick icons and a plurality of collection areas wherein each of the plurality of user selectable pick icons corresponds to one of the plurality of collection areas, display a plurality of award icons each of the plurality of award icons including an award value wherein each of the plurality of award icons is assigned to one of the plurality of collection areas, receive by the input device a selection of a pick icon of the plurality of user selectable pick icons, based on the received selection transform one of the plurality of collection areas into an activated collection area, and award each award value included on the plurality of award icons assigned to the activated collection area.

In another aspect, an electronic gaming system is described.

The electronic gaming system includes a display device, an input device operable to receive a player input, a memory device storing instructions, and a processor in communication with the display device and the memory device. The instructions, when executed by the processor, cause the processor to: display a base game outcome of a base game on the display device, determine that a feature game is triggered from the base game outcome, in response to the determination display the feature game including a plurality of user selectable pick icons and a plurality of collection areas wherein each of the plurality of user selectable pick icons corresponds to one of the plurality of collection areas, display a plurality of award icons each of the plurality of award icons including an award value wherein each of the plurality of award icons is assigned to one of the plurality of collection areas, receive by the input device a selection of a pick icon of the plurality of user selectable pick icons, in response to the selection, cause the collection area associated with the selected pick icon to transform into an activated collection area, and award each award value included on the plurality of award icons included within the activated collection area.

In yet another aspect, a method of electronic gaming is provided. The method includes displaying a base game outcome of a base game on a display device wherein the base game outcome includes a plurality of displayed symbols included on a plurality of reels, determining that the plurality of displayed symbols includes a wild symbol, in response to the determination displaying a feature game comprising a plurality of user selectable pick icons and a plurality of collection areas wherein each of the plurality of user selectable pick icons corresponds to one of the plurality of collection areas, displaying a plurality of award icons, each of the plurality of award icons including a prize wherein each of the plurality of award icons is assigned to one of the plurality of collection areas, receiving by an input device a selection of a pick icon of the plurality of user selectable pick icons, based on the selection transforming one of the plurality of collection areas into an activated collection area, and awarding each prize included on the plurality of award icons assigned to the activated collection area.

### BRIEF DESCRIPTION OF THE DRAWINGS

FIG. 1 is an exemplary diagram showing several EGMs networked with various gaming related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIG. 4 is an example user interface or screenshot of a base game of an example electronic game in accordance with the present disclosure, played on an electronic gaming machine similar to the ones shown in FIG. 1.

FIG. 5 is an example user interface or screenshot of the base game shown in FIG. 4.

FIG. 6 is an example user interface or screenshot of a feature game of the example electronic game in accordance with the present disclosure.

FIGS. 7-11 are example user interfaces or screenshots of the feature game shown in FIG. 6.

FIG. 12 is an example user interface or screenshot of a bonus game of the example electronic game in accordance with the present disclosure.

### DETAILED DESCRIPTION

The present application is directed to electronic gaming, and more specifically, to computer based electronic gaming systems and methods that include a gaming computer device having a processor programmed to cause the display of an improved feature game having user-initiated pick selections that enable improved game play variability and game play outcomes while conserving computational resources. For example, the improved feature game described herein may be used in Class III (e.g., RNG based) games, as described elsewhere herein. In the example embodiment, a base game is provided. A base game outcome of the base game includes symbols being displayed on a display device on reels within a display matrix wherein each reel is configured to spin (e.g., mechanically or virtually). In some embodiments, the base game outcome may include one or more wild symbols (e.g., symbols that may act as any other symbol to form a winning combination of symbols) or some other predefined trigger symbol. Each base game spin may display new symbols.

In some embodiments, certain base game outcomes (e.g., display of a certain number of one or more symbols) may trigger one or more feature games. One or more wild symbols may trigger the feature game, or one or more trigger symbols may trigger the feature game. In the example embodiment, the feature game includes a plurality of pick icons, one of which may be selected by a user or player and then activated once selected by the user or player. The processor of the gaming computer device may be programmed to display and/or indicate on the display device the selected or activated pick icon.

Once the feature game is triggered, the feature game includes one or more award icons that display outputs or possible awards or award amounts for certain game play outcomes (such as, but not limited to, credit amounts and/or jackpot amounts). The one or more processors assign the award icons to one or more of the plurality of pick icons, and this assignment may cause the display of the award icons in a collection area associated with the selected pick icon and/or the other pick icons. Upon termination/completion of the feature game, the processor causes the outputs displayed for the award icons in the collection area associated with the selected pick icon to be awarded (such as, but not limited to, a total credit amount and/or a total jackpot amount). In some embodiments, the processor may cause one or more of the award icons to display “CLAIM JUMPER” or some other indicator of additional picks being accepted, which may cause one or more additional pick icons of the plurality of pick icons to be automatically or user selected, and then activated once selected (e.g., activation of one or more additional pick icons). Upon termination/completion of the feature game, the processor causes the outputs displayed by the award icons in the activated collection area (e.g., activated collection area) associated with the one or more additional selected pick icons to be awarded (e.g., awarding of award icons in an additional activated collection area) to the player.

For example, as part of a feature game, multiple “characters” in mine carts (e.g., user selectable pick icons) may be displayed on the display device, each of which are available to be selected (e.g., picked) by a player. When a character is selected, “mines” (e.g., collection areas) may be displayed under the characters, with one mine associated with each character and displayed under the associated character. One or more gold nuggets (e.g., award icons) each displaying an output or award (e.g., credit amounts and/or jackpot amounts) may then be displayed, appearing to “fill” the mines under the characters. Upon termination/completion of the feature game, the processor which caused these gold nuggets to be displayed in the collection areas further causes the outputs displayed by the gold nuggets in the mine associated with the selected character(s) to be awarded (e.g., awarding a total credit amount and/or a total jackpot amount) to the player. If one or more gold nuggets displaying “CLAIM JUMPER” are caused to be displayed by the processor, one or more additional characters may be selected, either automatically or by the user, and the outputs displayed by the gold nuggets in the one or more mines associated with the one or more additional characters may also be awarded to the player.

In some embodiments, certain base game outcomes (e.g., display of a certain number of one or more symbols) and/or certain feature game outcomes (e.g., display of a certain output of one or more award icons) may trigger the processor to trigger one or more bonus games. In the example embodiment, the bonus game includes the processor causing the plurality of pick icons to be displayed, one of which may be selected by the player/user. The bonus game also includes one or more award icons that display bonus outputs (such as, but not limited to, a number of free spins) and one or more bonus symbols, which are caused to be displayed by the processor of the gaming computer device. The bonus symbols may be a subset of the symbols caused to be displayed on the reels in the base game (e.g., generate a symbol subset). The one or more award icons may be assigned to one or more of the plurality of pick icons and this assignment may cause the display of the award icons in a collection area associated with the selected pick icon. The one or more bonus symbols may also be assigned to one or more of the plurality of pick icons and this assignment may cause the display of the bonus symbols in the collection area associated with the selected pick icon. Upon termination/completion of the bonus game, the processor causes the outputs displayed on the award icons in the collection area associated with the selected pick icon to be awarded (such as, but not limited to, a total number of free spins) and the bonus symbols displayed in the collection area associated with the selected pick icon may be removed from the reels in the base game prior to initiation of the awarded free spins (e.g., additional game outcomes).

For example, as part of a bonus game, the processor may cause multiple “characters” in mine carts (e.g., pick icons) to be displayed, each of which are available to be selected (e.g., picked) by a player. When a character is selected, “mines” (e.g., collection areas) may be displayed under the characters, with one mine associated with each character and displayed under the associated character. One or more gold nuggets (e.g., award icons) displaying bonus outputs (e.g., a number of free spins) may then be displayed, appearing to “fill” the mines under the characters. Upon termination/completion of the feature game, the processor may cause the outputs displayed by the gold nuggets in the mine associated with the selected character to be awarded (e.g., awarding a total number of free spins) and the symbols displayed in the mine associated with the selected character may be removed from the reels in the base game prior to initiation of the awarded free spins.

Certain technical problems arise when implementing an electronic game that includes a feature game having user-initiated pick selections or user-selectable pick icons. For example, certain gaming devices that execute games without user-initiated pick selections and associated awards may provide inconsistent awards and/or communicate a negative impact on award probability. These known games also lack game variability. Additionally, certain gaming devices that execute games with a bonus game triggered from only one of a base game or a feature game may provide a negative impact on award probability. Further, a gaming device that executes a game with user-initiated pick selections needs to include proper control functions to implement the operation/capability while complying with gaming regulations such as achieving a designated game RTP. A gaming device that executes a game with user-initiated pick selections also needs to perform these functions while conserving computational resources but still proving game variability,

Embodiments of the present disclosure represent a technical improvement in the field of electronic gaming. Technical improvements represented by the present disclosure include at least: (i) a gaming device programmed to generate and cause display of an electronic game that may provide an improved award probability by presenting a potential for a pick icon to be selected by a user; (ii) a gaming device programmed to generate and cause display of an electronic game that may provide an improved award probability by presenting a potential for the awards associated with multiple pick icons to be awarded following the user selection of only one pick icon; and (iii) a gaming device programmed to generate and cause display of an electronic game that may provide an improved award probability by presenting a potential for triggering a bonus game from a base game and/or a feature game.

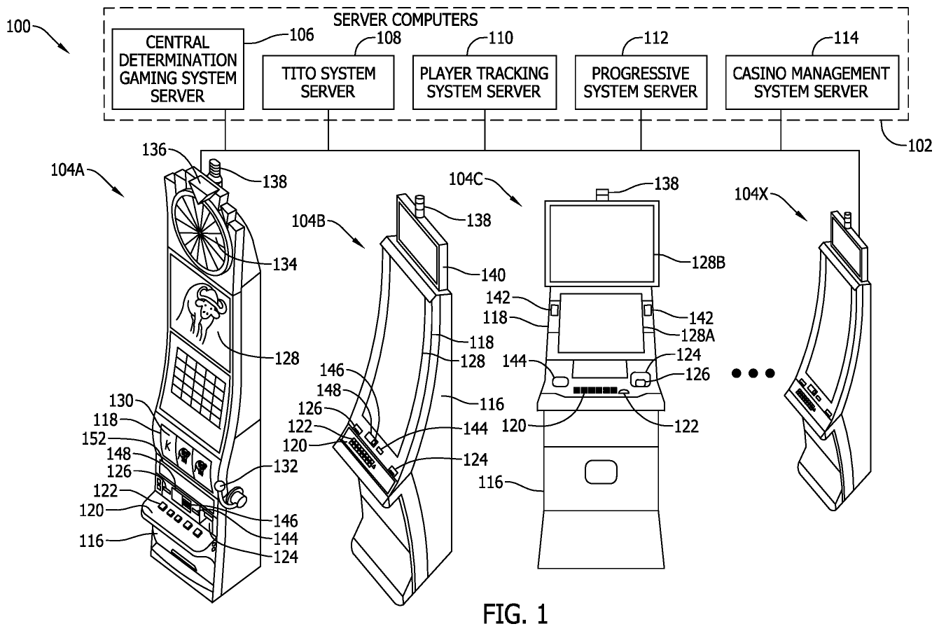

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementation, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

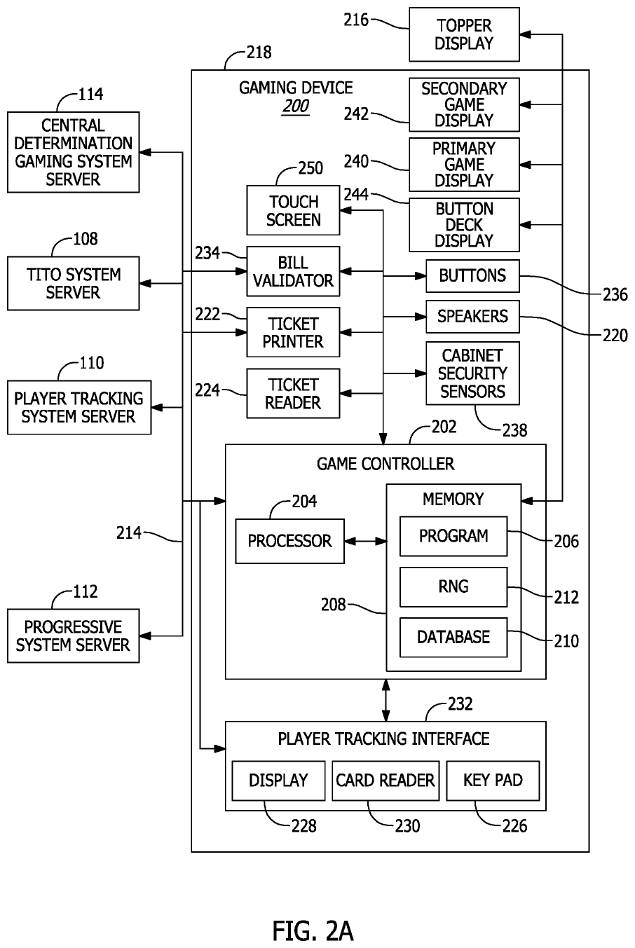

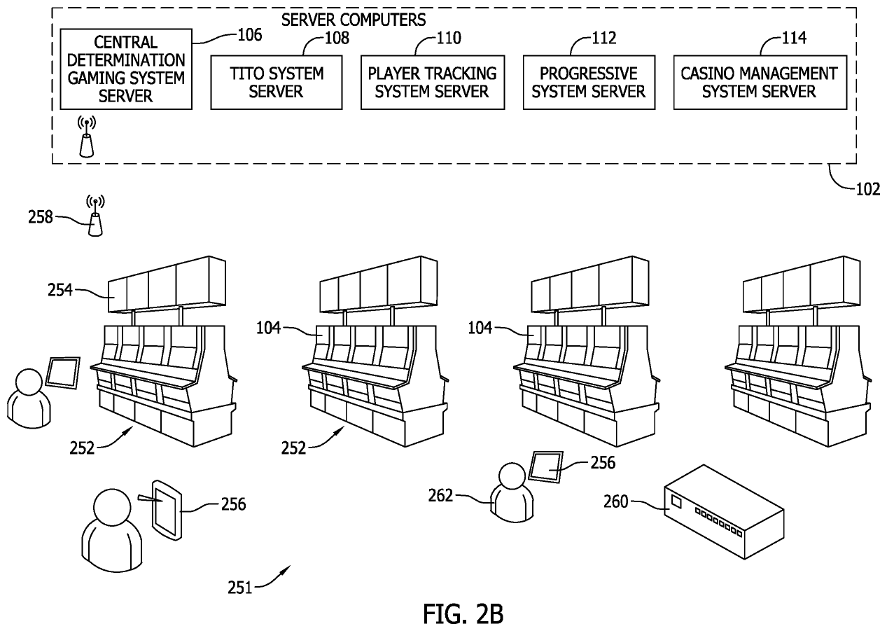

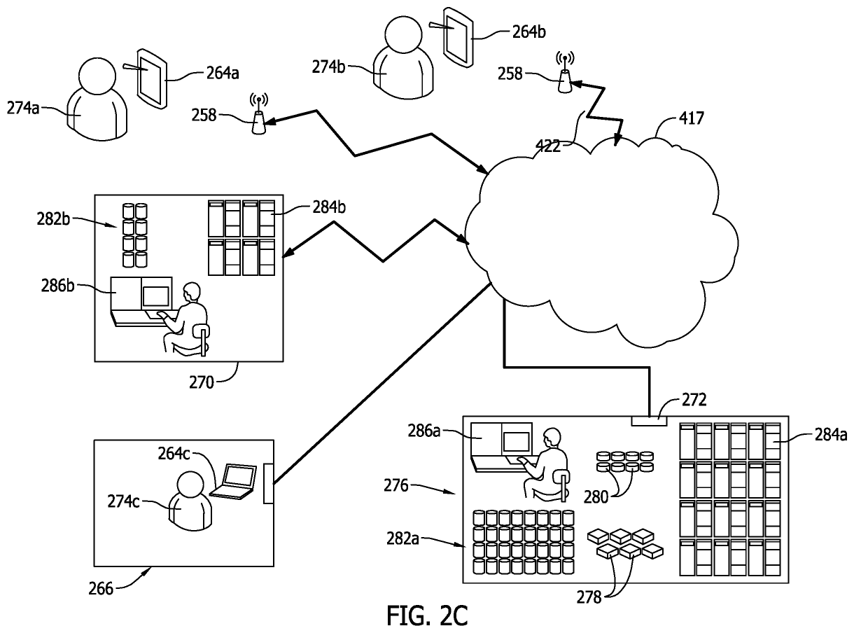

Many or all the above described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play or any other information or media desired by the game designer or operator. In some implementations, example gaming device 104C may also include speakers 142 to output various audio such as game sound, background music, etc.

Many different types of games, including mechanical slot games, video slot games, video poker, video blackjack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g., amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming.

For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 286a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

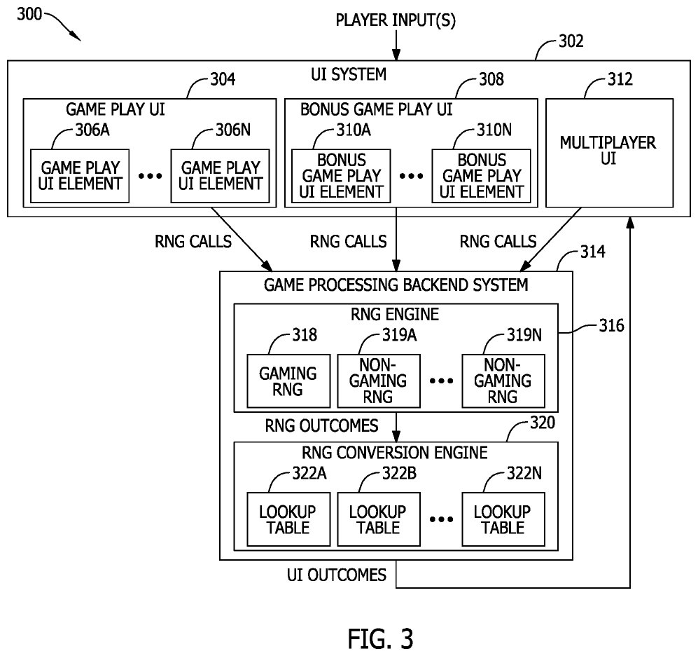

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

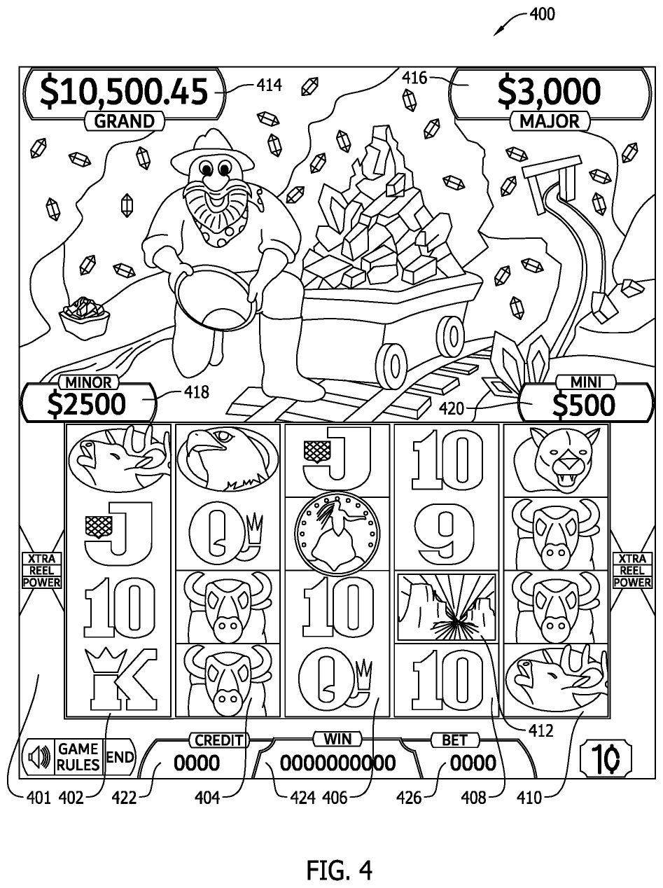

FIG. 4 is an example user interface or screenshot 400 of a base game of an example electronic game in accordance with the present disclosure. In the example of FIG. 4, a plurality of reels 402-410 are caused to be displayed in a primary game display area 401 of a gaming device (e.g., gaming devices 104A-104X, 256, and/or 264a-264c) by a game controller (e.g., game controller 202). While five reels 402-410 are shown in the example of FIG. 4, in some examples, more or fewer reels may be used. In some examples, reels 402-410 may be implemented as mechanical reels or may include virtual reels that are computer generated and displayed on a computer display screen/display device. As shown, each reel of reels 402-410 includes a plurality of symbol display positions for presenting symbols (and/or symbol combinations) which may be associated with winning and/or losing reel game outcomes and/or awards.

In operation, during game play of the base game, game controller 202 (shown in FIG. 2A) may cause display of a plurality of symbols on reels 402-410. The plurality of symbols may include a wild symbol 412. Wild symbol 412 may be displayed having an appearance that matches a base game theme. For example, as shown in FIG. 4, wild symbol 412 may be displayed having an appearance that matches a Buffalo base game theme. In some examples, wild symbol 412 may be displayed having an alternative appearance, such as an appearance that matches a Pompei or a Geisha base game theme.

The display of wild symbol 412 (or some other predefined trigger symbol) may cause game controller 202 to evaluate a trigger lookup table (not shown in figures) saved in memory. The trigger lookup table may include one or more trigger results, including, but not limited to, true and/or false, and game controller 202 may cause to be selected one of the trigger lookup results. The selection of the trigger lookup result from the trigger lookup table may be random for a Class III (RNG based) game. A trigger lookup table result of true may cause game controller 202 to initiate a feature game. In some examples, the display of wild symbol 412 may not cause an action by game controller 202, such as for a trigger lookup table result of false.

As part of the base game, game controller 202 may cause to be displayed a plurality of jackpot meters 414-420 in primary game display area 401, including, but not limited to, a grand jackpot meter 414, a major jackpot meter 416, a minor jackpot meter 418, and/or a mini jackpot meter 420. Credit values may be displayed in jackpot meters 414-420 to be awarded if a respective jackpot is won. Additionally, as part of the base game, game controller 202 may cause to be displayed a credit meter 422, a win meter 424, and/or a bet meter 426. Credit meter 422 may display a total credit value attributed to a player (e.g., user) and/or a player account. Win meter 424 may display a win value to be awarded to the user from spins of reels 402-410. Bet meter 426 may display a bet value for each spin of reels 402-410.

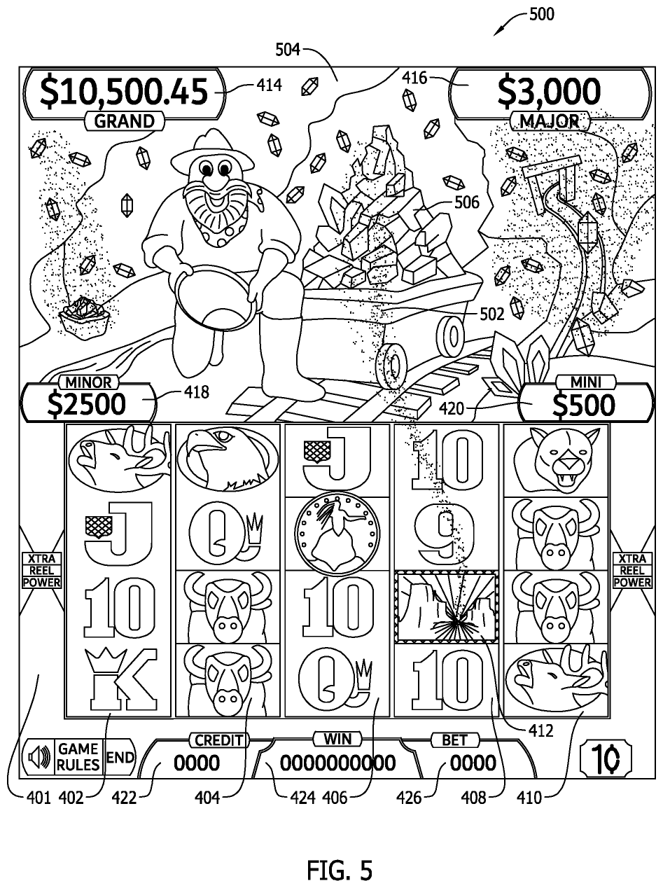

FIG. 5 is an example user interface or screenshot 500 of the base game of the example electronic game, continuing the example shown in FIG. 4. The initiation of the feature game may cause game controller 202 (shown in FIG. 2A) to display a wild symbol animation 502. For example, as shown in FIG. 5, wild symbol animation 502 may be displayed to appear as a streak of light traveling from wild symbol 412 to a graphic 504 above reels 402-410. Graphic 504 may include a metamorphic 506 (e.g., a transforming animation) associated with an amount of wild symbols 412 displayed on reels 402-410. For example, as shown in FIG. 5, metamorphic 506 may be displayed by game controller 202 to appear as a pile of gold that grows as an increasing amount of wild symbols 412 are displayed on reels 402-410. Wild symbol animation 502 may be displayed to appear to extend from wild symbol 412 to metamorphic 506 to communicate to the user to the user the increasing amount of wild symbols 412 displayed on reels 402-410 over multiple spins.

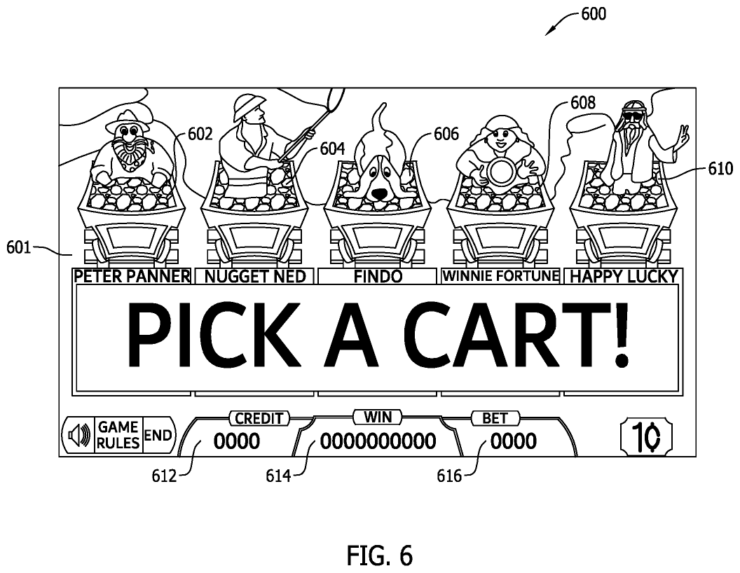

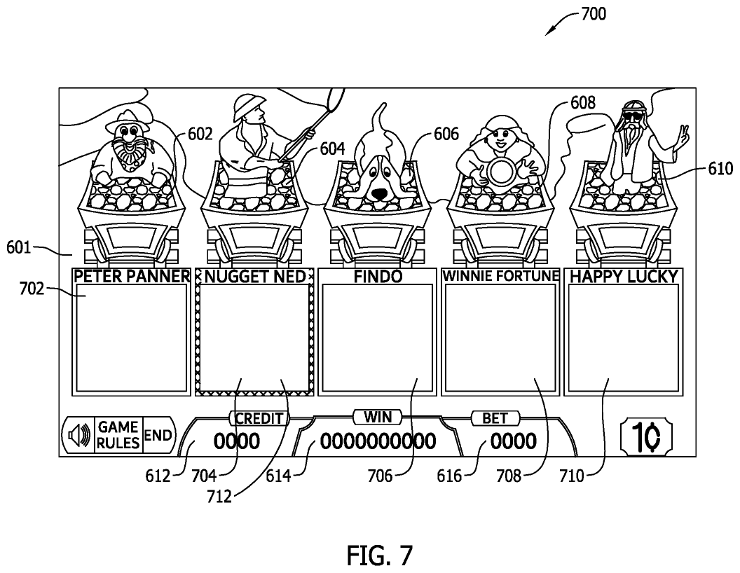

FIGS. 6-7 are example user interfaces or screenshots 600-700 of a feature game of the example electronic game in accordance with the present disclosure. In the example of FIG. 6, a plurality of pick icons 602-610 are displayed in a secondary game display area 601 of the gaming device (e.g., gaming devices 104A-104X) by a game controller (e.g., game controller 202). The plurality of pick icons 602-610 may include, but is not limited to, a first pick icon 602, a second pick icon 604, a third pick icon 606, a fourth pick icon 608, and/or a fifth pick icon 610. For example, as shown in FIG. 6, the plurality of pick icons 602-610 may appear as “characters” in mine carts, with each of the plurality of pick icons 602-610 appearing as a different character. In some examples, pick icons 602-610 may be randomly selected from a larger set of available pick icons, such as via an evaluation by game controller 202 of a pick icon lookup table (not shown in figures) saved in memory.

As part of the feature game, game controller 202 may cause to be displayed a feature credit meter 612, a feature win meter 614, and/or a feature bet meter 616. In some examples, credit values displayed by feature credit meter 612, feature win meter 614, and/or feature bet meter 616 in secondary game display area 601 may correspond to credit values displayed by credit meter 422, win meter 424, and/or bet meter 426, respectively, in primary game display area 401. Additionally, as part of the feature game, game controller 202 may cause to be displayed a plurality of feature jackpot meters (not shown in figures) in secondary game display area 601, including, but not limited to, a feature grand jackpot meter, a feature major jackpot meter, a feature minor jackpot meter, and/or a feature mini jackpot meter. Credit values may be displayed in the feature jackpot meters to be awarded if a respective feature jackpot is won. In some examples, credit values displayed by the feature jackpot meters in secondary game display area 601 may correspond to credit values displayed by grand jackpot meter 414, major jackpot meter 416, minor jackpot meter 418, and/or mini jackpot meter 420 in primary game display area 401.

In operation, during game play of the feature game, a selection by a user of one of the plurality of pick icons 602-210 may cause game controller 202 to display a plurality of collection areas 702-710. The plurality of collection areas 702-710 may include, but are not limited to, a first collection area 702, a second collection area 704, a third collection area 706, a fourth collection area 708, and/or a fifth collection area 710. Each of collection areas 702-710 may be associated with one of pick icons 602-610. For example, as shown in FIG. 7, each of the plurality of pick icons 602-610 may be associated with a collection area of the plurality of collection areas 702-710 (such as first collection area 702 being associated with first pick icon 602).

The user-initiated selection of one of the plurality of pick icons 602-610 may cause game controller 202 to cause to display an activated collection area 712 below the selected pick icon, transforming the associated collection area of collection areas 702-710 into the activated collection area 712. For example, as shown in FIG. 7, the user-initiated selection of pick icon 604 may cause to be displayed the transformation of second collection area 704, associated with pick icon 604, into activated collection area 712. The transformation of the collection area into activated collection area 712 may be displayed to appear as a border color change around activated collection area 712 to communicate to the user the collection area associated with the selected pick icon.

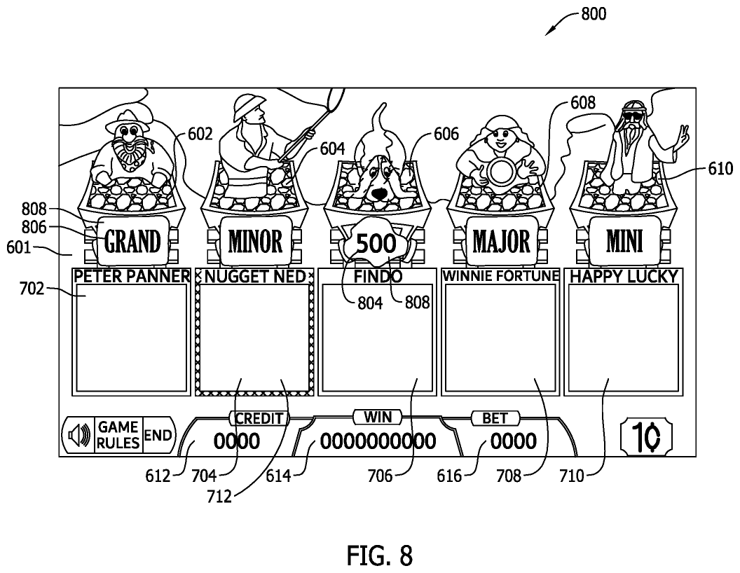

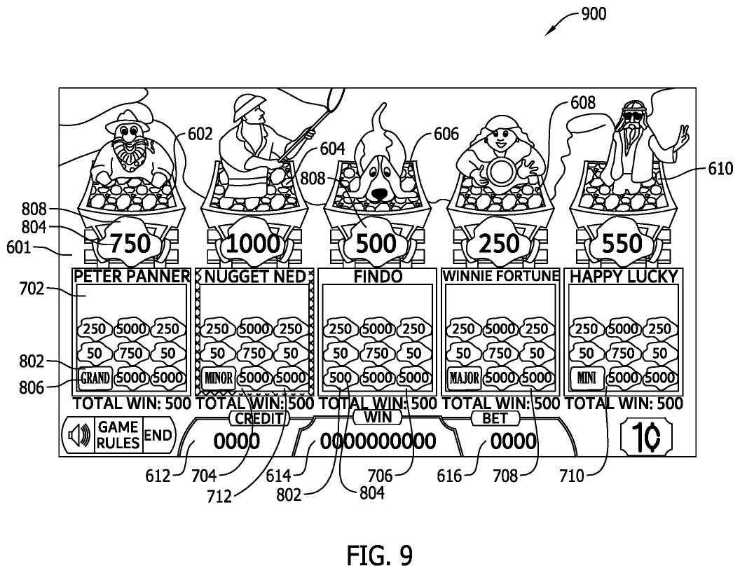

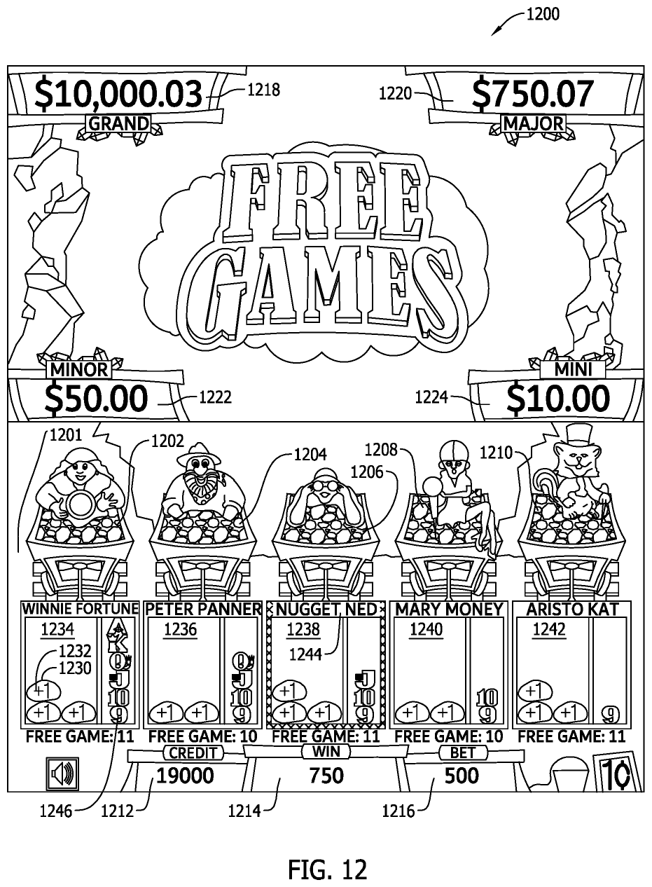

FIGS. 8-9 are example user interfaces or screenshots 800-900 of the feature game of the example electronic game, continuing the examples shown in FIGS. 6-7. In operation, during game play of the feature game, game controller 202 (shown in FIG. 2A) may cause to be displayed one or more of an award icon 802 (shown in FIG. 9) in secondary game display area 601. Each award icon 802 may include one of a plurality of outputs, including, but not limited to, a credit output 804 and/or a jackpot output 806. Credit output 804 may include a credit value to be awarded. Jackpot output 806 may include a jackpot award associated with one of jackpot meters 414-420 (shown in FIGS. 4-5) and/or the plurality of feature jackpot meters (not shown in Figures). In some examples, the plurality of outputs may include a bonus game output (not shown in Figures) to trigger (e.g., cause display of) a bonus game (as discussed in more detail with respect to FIG. 12), such as an output of “free games” or “free spins” to trigger the bonus game.

Prior to display of one or more of award icon 802, game controller 202 may cause the evaluation of one or more output lookup tables (not shown in figures) saved in memory. The one or more output lookup tables may include the plurality of outputs available to be included with award icon 802 and game controller 202 may cause to be selected an output of the plurality of outputs for each award icon 802 displayed. In some examples, the selection of the output from the plurality of outputs and/or the number of outputs selected from the output lookup table may be random for a Class III (RNG based) game. In other examples, the selection of the output from the plurality of outputs and/or the number of outputs selected from the output lookup table may be predetermined.

The one or more output lookup tables may include, but is not limited to, a high output lookup table (not shown in figures) and/or a low output lookup table (not shown in figures). The high output lookup table may include a subset of the plurality of outputs corresponding to outputs with higher values (e.g., higher credit values and/or higher jackpot awards). The low output lookup table may include a subset of the plurality of outputs corresponding to outputs with lower values (e.g., lower credit values and/or lower jackpot awards). In some examples, game controller 202 may cause the evaluation of the high output lookup table at least once during game play of the feature game. In other examples, game controller 202 may cause a sequence of evaluations of the high output lookup table and/or the low output lookup table (such as a sequence of evaluating the low output lookup table four times in a row and then evaluating the high output lookup table once).

When the output is selected from the one or more output lookup tables to be included with award icon 802, game controller 202 may cause the evaluation of a pick icon assignment lookup table (not shown in figures) saved in memory. The pick icon assignment lookup table may include pick icons 602-610 and game controller 202 may cause to be selected a pick icon of the plurality of pick icons 602-610 to be associated with the selected output included with award icon 802. In some examples, the selection of the pick icon from the plurality of pick icons 602-610 and/or the number of pick icons selected from the pick icon assignment lookup table may be random for a Class III (RNG based) game. In other examples, the selection of the pick icon from the plurality of pick icons 602-610 and/or the number of pick icons selected from the pick icon assignment lookup table may be predetermined. In still other examples, a selection order of each selection of the pick icon from the pick icon assignment lookup table may be predetermined. Although the number of award icons in each of the plurality of collection areas 702-710 are shown in FIG. 9 to be the same, the number of award icons selected and associated with each of the plurality of pick icons 602-610 may vary across collection areas 702-710. In some examples, the number of award icons associated with each of collection areas 702-710 may be random for a Class III (RNG based) game. In other examples, the number of award icons associated with each of collection areas 702-710 may be predetermined.

In the example embodiment, game controller 202 may complete all lookup table selections, including, but not limited to, the output lookup table and/or the pick icon assignment lookup table, before a user-initiated selection of a pick icon is received. For example, once a feature game is initiated and prior to the user-initiated selection of a pick icon, game controller 202 may determine the number of outputs to be selected from the output lookup table, determine the pick icon to be associated with each of the determined number of outputs, and/or select an output from the plurality of outputs for each of the determined number of outputs associated with each pick icon. In some embodiments, the order of these steps may vary. In other embodiments, the pick icons may be shuffled prior to associating one or more of the plurality of outputs with each of the plurality of pick icons 602-610.

In operation, during game play of the feature game, game controller 202 may cause to be displayed the output selected from the output lookup table on a next award icon 808 associated with the selected pick icon from the pick icon assignment lookup table. For example, as shown in FIG. 8, next award icon 808 associated with pick icon 602 includes jackpot output 806 associated with grand jackpot meter 414 (shown in FIG. 4) and/or the feature grand jackpot meter (not shown in Figures). Additionally, for example, as shown in FIG. 8, next award icon 808 associated with pick icon 606 includes credit output 804 of 500 credits.

Game controller 202 may continue to cause the evaluation of the one or more output lookup tables and/or the pick icon assignment lookup table, thereby causing the display of additional award icons 802, until the termination/completion of the feature game. When an output is selected from the one or more output lookup tables, and then associated with the pick icon selected from the pick icon assignment lookup table, game controller 202 may cause the display of the resulting award icon 802 within the collection area of collection areas 702-710 corresponding to the selected pick icon. Following this display, game controller 202 may cause the display of additional award icons 802, first as next award icon 808 and then within one of the plurality of collection areas 702-710, as additional outputs and pick icons are selected from the respective lookup tables.

For example, as shown in FIG. 9, one of award icon 802 within first collection area 702 includes jackpot output 806 associated with grand jackpot meter 414 (shown in FIG. 4) and/or the feature grand jackpot meter (not shown in Figures), which was previously shown in FIG. 8 as next award icon 808 assigned to pick icon 602. Similarly, for example, as shown in FIG. 9, one of award icon 802 within third collection area 706 includes credit output 804 of 500 credits, previously shown in FIG. 8 as next award icon 808 assigned to pick icon 606. In each of these examples, next award icon 808 now shows a new output selected from the output lookup table. In some examples, a repeat output may be selected, such as the same value of credit output 804, for subsequent award icons 802. In other examples, the output of subsequent award icons 802 may not repeat, with each award icon 802 including a unique output.

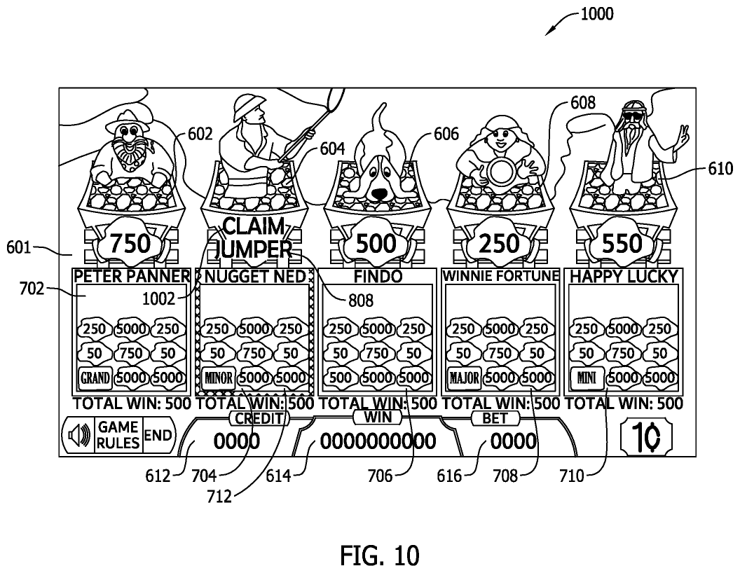

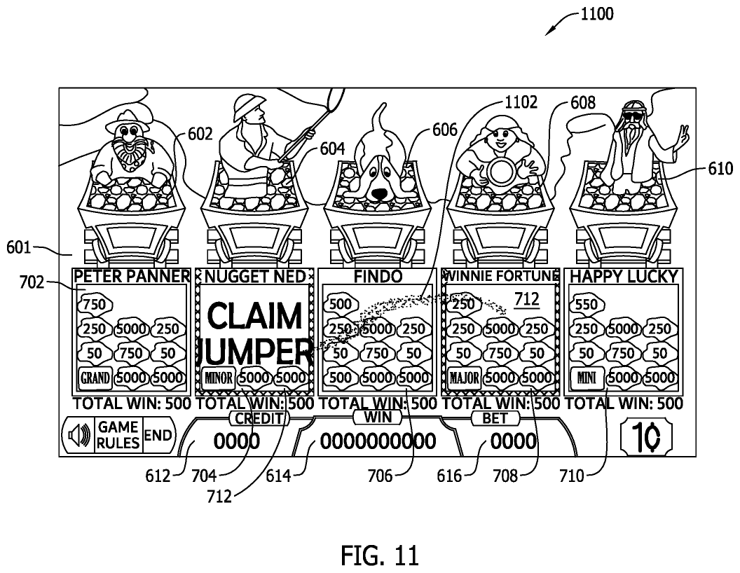

FIGS. 10-11 are example user interfaces or screenshots 1000-1100 of the feature game of the example electronic game, continuing the examples shown in FIGS. 6-9. The plurality of outputs included in the one or more output lookup tables (not shown in Figures) saved in memory may include an extra pick output 1002. In the example game, controller 202 (shown in FIG. 2A) outputs extra pick output 1002 from the one or more output tables, game controller 202 may cause the evaluation of the pick icon assignment lookup table to select an extra pick icon of the plurality of pick icons 602-610 (e.g., activates an additional pick icon). For example, as shown in FIG. 10, in response to selecting the extra pick output 1002 from the one or more output lookup tables, game controller 202 (shown in FIG. 2A) may cause to be displayed the words “CLAIM JUMPER” (or some other indicator) on next award icon 808. In some examples, only one extra pick output 1002 may be available for each of the plurality of pick icons 602-610, thereby allowing only one extra pick output 1002 to be selected from the one or more output lookup tables for each of the plurality of collection areas 702-710.

In response to selecting the extra pick output 1002 from the one or more output lookup tables, game controller 202 may also cause to be displayed an extra pick output animation 1102. The extra pick output animation 1102 may be displayed to appear as the words “CLAIM JUMPER” moving from the collection area associated with the user-initiated pick icon selection to the collection area associated with the extra pick output 1002. For example, as shown in FIG. 11, the words “CLAIM JUMPER” appear to move from second collection area 704, associated with the user-initiated selection of second pick icon 604, to the collection area associated with the pick icon selection from the pick icon assignment lookup table. In this example, the words “CLAIM JUMPER” appear to move to the fourth collection area 708, associated with the fourth pick icon 608 selected as extra pick output 1002. Additionally, the extra pick output animation 1102 may be displayed to appear as a moving arc of light between the applicable collection areas. For example, as shown in FIG. 11, the arc of light appears to move from second collection area 704 to fourth collection area 708.

Following the display of the extra pick output animation 1102, the game controller 202 may cause to be displayed the transformation of the additional collection area associated with the extra pick output 1002 into activated collection area 712. The transformation of the additional collection area into activated collection area 712 may be displayed to appear as a border color change around activated collection area 712 to communicate to the user the collection area associated with the extra pick output 1002. The transformation of the additional collection area into activated collection area 712 may include a sequence of animations to make it appear as though the border color change is traveling between the applicable collection areas until the border color change “lands” on the collection area associated with extra pick output 1002.

In some game play instances, extra pick output 1002 may be displayed in more than one activated collection area 712. For example, following a user-initiated selection of a pick icon, game controller 202 may cause the selection of the extra pick output 1002 to be displayed in the activated collection area 712 associated with the selected pick icon. In response to this selection, game controller 202 may cause to be displayed the extra pick output animation 1102 to transform an additional collection area into activated collection area 712. In some examples, this chain of events may continue to repeat until all of the plurality of collection areas 702-710 have been transformed into activated collection area 712 following the selection by game controller 202 of multiple of extra pick output 1002 from the one or more output lookup tables.

In the example embodiment, game controller 202 may complete all lookup table selections pertaining to extra pick output 1002, including, but not limited to, the output lookup table and/or the pick icon assignment lookup table, before a user-initiated selection of a pick icon is received. For examine, once a feature game is initiated and prior to the user-initiated selection of a pick icon, game controller 202 may determine the number of extra pick output 1002 to be selected from the output lookup table and/or determine the pick icon to be associated with each of the determined number of extra pick output 1002. In some embodiments, the order of these steps may vary.

FIG. 12 is an example user interface or screenshot 1200 of a bonus game of the example electronic game in accordance with the present disclosure. The bonus game may include free games and may be triggered from the base game and/or the feature game. For example, the landing of three or more trigger symbols (e.g., scatter symbols) during play of the base game may trigger the bonus game. Further to this example, the number of free games may be awarded corresponding to the number of trigger symbols that landed during play of the base game (e.g., three trigger symbols may award eight free games, four trigger symbols may award twelve free games, etc.). In the example of FIG. 12, a plurality of bonus pick icons 1202-1210 are displayed in a bonus game display area 1201 of the gaming device (e.g., gaming devices 104A-104X) by a game controller (e.g., game controller 202).

The plurality of bonus pick icons 1202-1210 may include, but is not limited to, a first bonus pick icon 1202, a second bonus pick icon 1204, a third bonus pick icon 1206, a fourth bonus pick icon 1208, and/or a fifth bonus pick icon 1210. For example, as shown in FIG. 12, the plurality of bonus pick icons 1202-1210 may be displayed to appear as “characters” in mine carts, with each of bonus pick icons 1202-1210 appearing as a different character. In some examples, bonus pick icons 1202-1210 may be randomly selected from a larger set of available bonus pick icons, such as via an evaluation by game controller 202 of a bonus pick icon lookup table (not shown in Figures) saved in memory. The set of available bonus pick icons from which bonus pick icons 1202-1210 are selected during the bonus game may be identical to the set of available pick icons from which pick icons 602-610 (shown in FIG. 6) are selected during the feature game.

As part of the bonus game, game controller 202 may cause to be displayed a bonus credit meter 1212, a bonus win meter 1214, and a bonus bet meter 1216. In some examples, credit values displayed by bonus credit meter 1212, bonus win meter 1214, and bonus bet meter 1216 may correspond to credit values displayed by credit meter 422 and/or feature credit meter 612, win meter 424 and/or feature win meter 614, and bet meter 426 and/or feature bet meter 616, respectively, in primary game display area 401 during the base game and/or secondary game display area 601 during the feature game.

Additionally, as part of the bonus game, game controller 202 may cause to be displayed a plurality of bonus jackpot meters 1218-1224 in bonus game display area 1201, including, but not limited to, a bonus grand jackpot meter 1218, a bonus major jackpot meter 1220, a bonus minor jackpot meter 1222, and/or a bonus mini jackpot meter 1224. Credit values may be displayed in bonus jackpot meters 1218-1224 to be awarded if a respective bonus jackpot is won. In some examples, credit values displayed by bonus jackpot meters 1218-1224 in bonus game display area 1201 during the bonus game may correspond to credit values displayed by jackpot meters 414-420, respectively, in primary game display area 401 during the base game.

In operation, during game play of the bonus game, a selection by a user of one of the plurality of bonus pick icons 1202-1210 may cause game controller 202 to display a plurality of bonus collection areas 1234-1242. The plurality of bonus collection areas 1234-1242 may include, but is not limited to, a first bonus collection area 1234, a second bonus collection area 1236, a third bonus collection area 1238, a fourth bonus collection area 1240, and/or a fifth bonus collection area 1242. Each of bonus collection areas 1234-1242 may be associated with one of bonus pick icons 1202-1210. For example, as shown in FIG. 12, each of the plurality of bonus pick icons 1202-1210 may be associated with one of the plurality of bonus collection areas 1234-1242 (such as first bonus collection area 1234 being associated with first bonus pick icon 1202).

The user-initiated selection of one of the plurality of bonus pick icons 1202-1210 may cause game controller 202 to display an activated bonus collection area 712 below the selected bonus pick icon, transforming the associated bonus collection area of bonus collection areas 1234-1242 into the activated bonus collection area 1244. For example, as shown in FIG. 12, the user-initiated selection of bonus pick icon 1206 may cause to be displayed the transformation of third bonus collection area 1238, associated with bonus pick icon 1206, into activated bonus collection area 1244. The transformation of the bonus collection area into activated bonus collection area 1244 may be displayed to appear as a border color change around activated bonus collection area 1244 to communicate to the user the bonus collection area associated with the selected bonus pick icon.

In operation, during game play of the bonus game, game controller 202 (shown in FIG. 2A) may cause to be displayed one or more of a bonus award icon 1230 in bonus game display area 1201. Each bonus award icon 1230 may include one of a plurality of bonus outputs, including, but not limited to, a free spin indicator 1232. The free spin indicator may include a number of free spins of reels 402-410 in the base game (shown in FIG. 4).

Prior to display of one or more of bonus award icon 1230, game controller 202 may cause the evaluation of one or more bonus output lookup tables (not shown in figures) saved in memory. The one or more bonus output lookup tables may include the plurality of bonus outputs available to be included with bonus award icon 1230 and game controller 202 may cause to be selected a bonus output from the plurality of bonus outputs for each bonus award icon 1230 displayed. In some examples, the selection of the bonus output from the plurality of bonus outputs and/or the number of bonus outputs selected from the bonus output lookup table may be random for a Class III (RNG based) game. In other examples, the selection of the bonus output from the plurality of bonus outputs and/or the number of bonus outputs selected from the output lookup table may be predetermined.

When the bonus output is selected from the one or more bonus output lookup tables to be included with bonus award icon 1230, game controller 202 may cause the evaluation of a bonus pick icon assignment lookup table (not shown in figures) saved in memory. The bonus pick icon assignment lookup table may include bonus pick icons 1202-1210 and game controller 202 may cause to be selected a bonus pick icon of bonus pick icons 1202-1210 to be associated with the selected output included with bonus award icon 1230. In some examples, the selection of the bonus pick icon from the plurality of bonus pick icons 1202-1210 and/or the number of bonus pick icons selected from the bonus pick icon assignment lookup table may be random for a Class III (RNG based) game. In other examples, the selection of the bonus pick icon from the plurality of bonus pick icons 1202-1210 and/or the number of bonus pick icons selected from the bonus pick icon assignment lookup table may be predetermined. In still other examples, a selection order of each bonus pick icon selected from the bonus pick icon assignment lookup table may be predetermined.

In operation, during game play of the bonus game, game controller 202 may cause to be displayed the bonus output selected from the bonus output lookup table on a subsequent of bonus award icon 1230 associated with the selected bonus pick icon. For example, as shown in FIG. 12, one of bonus award icon 1230 associated with bonus pick icon 1202 is displayed in first bonus collection area 1234 and includes free spin indicator 1232 of +1 (e.g., adding one free spin). Game controller 202 may continue to cause the evaluation of the one or more bonus output tables and/or the bonus pick icon assignment lookup table, thereby causing the display of additional bonus award icons 1230, until the termination/completion of the bonus game. Although the number of bonus award icons in each of bonus collection areas 1234-1242 are shown in FIG. 12 to vary, the number of bonus award icons may be identical across bonus collection areas 1234-1242. In some examples, the number of bonus award icons for each of bonus collection areas 1234-1242 may be random for a Class III (RNG based) game. In other examples, the number of bonus award icons for each of bonus collection areas 1234-1242 may be predetermined.

Additionally, in operation, during game play of the bonus game, game controller 202 may cause to be displayed one or more of a symbol icon 1246. Each symbol icon 1246 may correspond with one of the plurality of symbols displayed on reels 402-410 of the base game (shown in FIG. 4). Upon termination/completion of the bonus game, the symbols of the plurality of symbols displayed on reels 402-410 in the base game that correspond with symbol icon 1246 in activated collection area 1244 of the bonus game may be removed from reels 402-410 prior to initiation of any free spins awarded from the bonus game. In the example of FIG. 12, reel symbols 9, 10, J (jack), as shown in activated collection area 1244, would be removed from reels 402-210 during play of the awarded free spin games. In some examples, the number of free spins of reels 402-410 may be the sum of each free spin indicator 1232 within activated collection area 1244 in the bonus game.

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

What is claimed is:

1. An electronic gaming device comprising:
a display device;
an input device operable to receive a player input;
a memory device for storing instructions; and
a processor in communication with the display device, the input device, and the memory device, wherein the instructions, when executed by the processor, cause the processor to:
display a base game outcome of a base game on the display device, the base game outcome comprising a plurality of displayed symbols included on a plurality of reels;
determine that the plurality of displayed symbols includes a trigger symbol;
in response to the display of the trigger symbol, display a feature game comprising a plurality of user selectable pick icons and a plurality of collection areas, wherein each of the plurality of user selectable pick icons corresponds to one of the plurality of collection areas;
display a plurality of award icons, each of the plurality of award icons including an award value, wherein each of the plurality of award icons is assigned to one of the plurality of collection areas;
receive by the input device a selection of a pick icon of the plurality of user selectable pick icons;
based on the received selection, transform one of the plurality of collection areas into an activated collection area; and
award each award value included on the plurality of award icons assigned to the activated collection area.

2. The electronic gaming device of claim 1, wherein the award value included on each of the plurality of award icons includes at least one of a credit value and a jackpot award.

3. The electronic gaming device of claim 1, wherein the award value included on each of the plurality of award icons includes an extra pick icon selection, wherein the extra pick icon selection transforms an additional collection area of the plurality of collection areas into an additional activated collection area.

4. The electronic gaming device of claim 3, further comprising causing the processor to award each award value included on the plurality of award icons assigned to the activated collection area and the additional activated collection area to a player account.

5. The electronic gaming device of claim 3, further comprising causing the processor to:
determine that the plurality of displayed symbols includes a bonus symbol;
in response to the determination, display a bonus game comprising a plurality of user selectable bonus pick icons and a plurality of bonus collection areas, wherein each of the plurality of user selectable bonus pick icons corresponds to one of the plurality of bonus collection areas;
display a plurality of bonus award icons and a plurality of bonus symbols, each of the plurality of bonus award icons including a bonus prize, wherein each of the plurality of bonus award icons and each of the plurality of bonus symbols are assigned to one of the plurality of bonus collection areas;
receive by the input device a selection of a bonus pick icon of the plurality of user selectable bonus pick icons;
based on the selection, transform one of the plurality of bonus collection areas into an activated bonus collection area; and
award each bonus prize included on the plurality of bonus award icons assigned to the activated bonus collection area, wherein the bonus prize included on each of the plurality of bonus award icons includes a number of free spins of the plurality of reels of the base game.

6. The electronic gaming device of claim 5, wherein the plurality of user selectable pick icons includes the plurality of user selectable bonus pick icons.

7. The electronic gaming device of claim 5, further comprising causing the processor to:
generate a symbol subset of the plurality of displayed symbols, wherein the symbol subset comprises the plurality of displayed symbols without the plurality of bonus symbols assigned to the activated collection area; and
display a number of additional base game outcomes of the base game comprising the symbol subset displayed on the plurality of reels, wherein the number of additional base game outcomes corresponds to the number of free spins.

8. The electronic gaming device of claim 5, wherein at least one of the award value and the bonus prize includes a bonus game trigger, wherein the bonus game trigger causes display of the bonus game.

9. An electronic gaming system comprising:
a display device;
an input device operable to receive a player input;
a memory device storing instructions; and
a processor in communication with the display device and the memory device, wherein the instructions, when executed by the processor, cause the processor to:
display a base game outcome of a base game on the display device;
determine that a feature game is triggered from the base game outcome;
in response to the determination, display the feature game comprising a plurality of user selectable pick icons and a plurality of collection areas, wherein each of the plurality of user selectable pick icons corresponds to one of the plurality of collection areas;
display a plurality of award icons, each of the plurality of award icons including an award value, wherein each of the plurality of award icons is assigned to one of the plurality of collection areas;
receive by the input device a selection of a pick icon of the plurality of user selectable pick icons;
in response to the selection, cause the collection area associated with the selected pick icon to transform into an activated collection area; and
award each award value included on the plurality of award icons included within the activated collection area.

10. The electronic gaming system of claim 9, wherein the award value included on each of the plurality of award icons includes at least one of a credit value and a jackpot award.

11. The electronic gaming system of claim 9, wherein the award value included on each of the plurality of award icons includes an extra pick icon selection, wherein the extra pick icon selection enables a user to select an additional collection area of the plurality of collection areas and transform the selected additional collection area into an additional activated collection area.

12. The electronic gaming system of claim 11, further comprising causing the processor to award each award value to a user account included on the plurality of award icons assigned to the activated collection area and the additional activated collection area.

13. The electronic gaming system of claim 11, further comprising causing the processor to:
determine that a bonus symbol is displayed;
in response to the determination, display a bonus game comprising a plurality of user selectable bonus pick icons and a plurality of bonus collection areas, wherein each of the plurality of user selectable bonus pick icons corresponds to one of the plurality of bonus collection areas;
display a plurality of bonus award icons and a plurality of bonus symbols, each of the plurality of bonus award icons including a bonus prize, wherein each of the plurality of bonus award icons and each of the plurality of bonus symbols are assigned to one of the plurality of bonus collection areas;
receive by the input device a selection of a bonus pick icon of the plurality of user selectable bonus pick icons;
based on the selection, transform one of the plurality of bonus collection areas into an activated bonus collection area; and
award each bonus prize included on the plurality of bonus award icons assigned to the activated bonus collection area, wherein the bonus prize included on each of the plurality of bonus award icons includes a number of free spins of the plurality of reels of the base game.

14. The electronic gaming system of claim 13, wherein the plurality of user selectable pick icons includes the plurality of user selectable bonus pick icons.

15. The electronic gaming system of claim 13, further comprising causing the processor to:
generate a symbol subset of a plurality of symbols for display within the base game, wherein the symbol subset comprises the plurality of symbols without the plurality of bonus symbols assigned to the activated collection area; and
display a number of additional base game outcomes of the base game comprising the symbol subset displayed on the plurality of reels, wherein the number of additional base game outcomes corresponds to the number of free spins.

16. The electronic gaming system of claim 13, wherein at least one of the prize and the bonus prize includes a bonus game trigger, wherein the bonus game trigger causes display of the bonus game.

17. A method of electronic gaming, the method comprising:
displaying a base game outcome of a base game on a display device, the base game outcome comprising a plurality of displayed symbols included on a plurality of reels;
determining that the plurality of displayed symbols includes a wild symbol;
in response to the determination, displaying a feature game comprising a plurality of user selectable pick icons and a plurality of collection areas, wherein each of the plurality of user selectable pick icons corresponds to one of the plurality of collection areas;
displaying a plurality of award icons, each of the plurality of award icons including a prize, wherein each of the plurality of award icons is assigned to one of the plurality of collection areas;
receiving by an input device a selection of a pick icon of the plurality of user selectable pick icons;
based on the selection, transforming one of the plurality of collection areas into an activated collection area; and
awarding each prize included on the plurality of award icons assigned to the activated collection area.

18. The method of claim 17, further comprising:
displaying the plurality of award icons, each of the plurality of award icons including at least one prize of an extra pick icon selection;
transforming an additional collection area of the plurality of collection areas into an additional activated collection area; and
awarding each prize included on the plurality of award icons assigned to the activated collection area and the additional activated collection area.

19. The method of claim 18, further comprising:
determining that the plurality of displayed symbols includes a bonus symbol;
in response to the determination, displaying a bonus game comprising a plurality of user selectable bonus pick icons and a plurality of bonus collection areas, wherein each of the plurality of user selectable bonus pick icons corresponds to one of the plurality of bonus collection areas;
displaying a plurality of bonus award icons and a plurality of bonus symbols, each of the plurality of bonus award icons including a bonus prize, wherein each of the plurality of bonus award icons and each of the plurality of bonus symbols are assigned to one of the plurality of bonus collection areas;
receiving by the input device a selection of a bonus pick icon of the plurality of user selectable bonus pick icons;
based on the selection, transforming one of the plurality of bonus collection areas into an activated bonus collection area; and
awarding each bonus prize included on the plurality of bonus award icons assigned to the activated bonus collection area, wherein the bonus prize included on each of the plurality of bonus award icons includes a number of free spins of the plurality of reels of the base game.

20. The method of claim 19, further comprising:
generating a symbol subset of the plurality of displayed symbols, wherein the symbol subset comprises the plurality of displayed symbols without the plurality of bonus symbols assigned to the activated collection area; and
displaying a number of additional base game outcomes of the base game comprising the symbol subset displayed on the plurality of reels, wherein the number of additional base game outcomes corresponds to the number of free spins.
